(19) United States
(12) Patent Application Publication
(10) Pub. No.: US 2012/0044111 A1
(43) Pub. Date: Feb. 23, 2012

(54) ANTENNA APPARATUS RESONATING IN PLURAL FREQUENCY BANDS IN INVERTED F ANTENNA

(76) Inventors: Masahiko Nagoshi, Osaka (JP); Wataru Noguchi, Hyogo (JP)

(21) Appl. No.: 13/259,380

(22) PCT Filed: Dec. 24, 2010
(86) PCT No.: PCT/JP2010/007489

§ 371 Date: Sep. 23, 2011

(30) Foreign Application Priority Data
Dec. 28, 2009 (JP) 2009-297388

(51) Int. Cl. H01Q 1/38

(52) U.S. Cl. 343/700 MS

(57) ABSTRACT

In an inverted F pattern antenna apparatus including a first antenna element and having an electrical length of a quarter wavelength of a first resonance frequency, a folded antenna element and a second antenna element are provided at an end portion of the first antenna element. A length having an electrical length obtained by adding the electrical length of the further provided antenna elements to the electrical length of the inverted F pattern antenna apparatus is set to an electrical length of a quarter wavelength of a second resonance frequency, then resonance is achieved at the second resonance frequency, thereby configuring the antenna apparatus having two resonance frequencies.

### TECHNICAL FIELD

The present invention relates to an antenna apparatus that resonates in a plurality of frequency bands in an inverted F antenna.

### BACKGROUND ART

FIG. 7 is a longitudinal sectional view showing a configuration of a prior art two-frequency resonance antenna apparatus. The two-frequency resonance antenna apparatus is disclosed as a configuration for making an inverted F antenna apparatus resonate in two frequency bands in the Patent Document 1. Referring to FIG. 7, the antenna apparatus is described below by using XY coordinates with one point on an upper surface 104a of a grounding conductor 104 defined as a coordinate origin O. The axis extending along the upper surface 104a of the grounding conductor 104 is defined as an X axis, and the axis extending from the coordinate origin O in a vertical direction (upward direction) from the upper surface 104a of the grounding conductor 104 is defined as a Y axis.

Referring to FIG. 7, a first antenna element 101 is configured to have a length of λα/4 and resonate at the wavelength λα. A second antenna element 102 is configured to have a length of λβ/4 and resonate at the wavelength λβ. A Y-direction long strip ψ is grounded at the coordinate origin O, and connected to the first antenna element 101 in the Y-axis direction. A Y-direction short strip y is connected to a feeding point 105 and connected to the second antenna element 102 in the vertical direction.

In the antenna apparatus as configured as above, impedance matching is obtained at the feeding point in the 2.45-GHz band and the 5-GHz band by the first antenna element 101 and the second antenna element 102, respectively, and a two-band antenna apparatus is configured. Further, in the Patent Document 1, the frequency band is expanded by arranging an L-figured parasitic element 103 between the second antenna element 102 and the upper surface 104a of the grounding conductor 104.

FIG. 8 is a graph showing a frequency characteristics of a voltage standing wave ratio (hereinafter, referred to as VSWR) upon transmitting in the two-frequency resonance antenna apparatus of FIG. 7. As shown in FIG. 8, it can be understood that the VSWR frequency characteristic (tuning characteristic) changes depending on the length dimension L of the parasitic element 103 shown in FIG. 7.

### PRIOR ART DOCUMENT

### Patent Document

Patent Document 1: Japanese patent laid-open publication No. JP 2006-238269 A

### SUMMARY OF THE INVENTION

### Problems to be Dissoved by the Invention

The Patent Document 1 has such a problem that it is demanded to be further reduced in size since the width of the antenna apparatus conforming to the longer wavelength is needed because the antenna apparatuses are arranged in two lines in the horizontal direction with respect to the grounding conductor in conformity with the two wavelengths.

An object of the present invention is to provide an antenna apparatus capable of being further reduced in size with resonating in two frequency bands in the inverted F antenna.

### Means for Solving the Problems

According to one aspect of the present invention, there is provided an antenna apparatus including a grounding antenna element, a first antenna element, a feeding antenna element, a folded antenna element, and a second antenna element. The grounding antenna element has one end connected to a grounding conductor. The first antenna element is formed to be substantially parallel to a peripheral edge portion of the grounding conductor, and the first antenna element has one end connected to another end of the grounding antenna element. The feeding antenna element connects a feeding point with a predetermined connecting point on the first antenna element, a folded antenna element has one end connected to another end of the first antenna element, and the second antenna element has one end connected to another end of the folded antenna element. A first length from the feeding point via the feeding antenna element, the connecting point on the first antenna element, and the first antenna element to another end of the first antenna element is set to a length of a quarter wavelength of a first resonance frequency, and this leads to that the antenna apparatus resonates at a first resonance frequency by a first radiating element having the first length. A second length from the feeding point via the feeding antenna element, the connecting point on the first antenna element, the first antenna element, the folded antenna element, the second antenna element to another end of the second antenna element is set to a length of a quarter wavelength of a second resonance frequency, and this leads to that the antenna apparatus resonates at a second resonance frequency by a second radiating element having the second length.

In the above-mentioned antenna apparatus, the grounding antenna element is formed to be substantially perpendicular to the peripheral edge portion of the grounding conductor. The folded antenna element is formed to be substantially perpendicular to the peripheral edge portion of the grounding conductor. The second antenna element is formed to be substantially parallel to the peripheral edge portion of the grounding conductor.

In addition, in the above-mentioned antenna apparatus, the first antenna element, the second antenna element, the folded antenna element, the feeding antenna element and the grounding antenna element are formed on a substrate.

Further, in the above-mentioned antenna apparatus, the folded antenna element has a width smaller than the width of each of the first antenna element and the second antenna element.

Still further, in the above-mentioned antenna apparatus, another end of the second antenna element is formed to be bent at a predetermined angle.

Still further, in the above-mentioned antenna apparatus, another end of the second antenna element is formed to be bent in a direction toward the peripheral edge portion of the grounding conductor.

Therefore, according to the invention, in the inverted F antenna, the width of the antenna apparatus can be made to be about half that of the prior art with resonating in two frequency bands, and its size can be remarkably reduced.

### BRIEF DESCRIPTION OF THE DRAWINGS

FIG. 1 is a plan view showing a configuration of an antenna apparatus according to a first preferred embodiment of the invention;

FIG. 2A is a graph showing a VSWR frequency characteristic in the vicinity of a second resonance frequency fβ in the antenna apparatus of FIG. 1;

FIG. 2B is a graph showing a VSWR frequency characteristic in the vicinity of a first resonance frequency fα in the antenna apparatus of FIG. 1;

FIG. 3 is a plan view showing a configuration of an antenna apparatus according to a second preferred embodiment of the invention; FIG. 4A is a graph showing a VSWR frequency characteristic in the vicinity of the second resonance frequency fβ in the antenna apparatus of FIG. 3;

FIG. 4B is a graph showing a VSWR frequency characteristic in the vicinity of the resonance frequency fα in the antenna apparatus of FIG. 3;

FIG. 5 is a plan view showing a configuration of an antenna apparatus according to a modified preferred embodiment of the first preferred embodiment;

FIG. 6 is a plan view showing a configuration of an antenna apparatus according to a modified preferred embodiment of the second preferred embodiment;

FIG. 7 is a longitudinal sectional view showing a configuration of a prior art two-frequency resonance antenna apparatus; and

FIG. 8 is a graph showing a VSWR frequency characteristic of the two-frequency resonance antenna apparatus of FIG. 7.

### DETAILED DESCRIPTION OF THE PREFERRED EMBODIMENTS

Preferred embodiments of the present invention will be described below with reference to the drawings. In the following preferred embodiments, like components are denoted by like reference numerals.

### First Preferred Embodiment

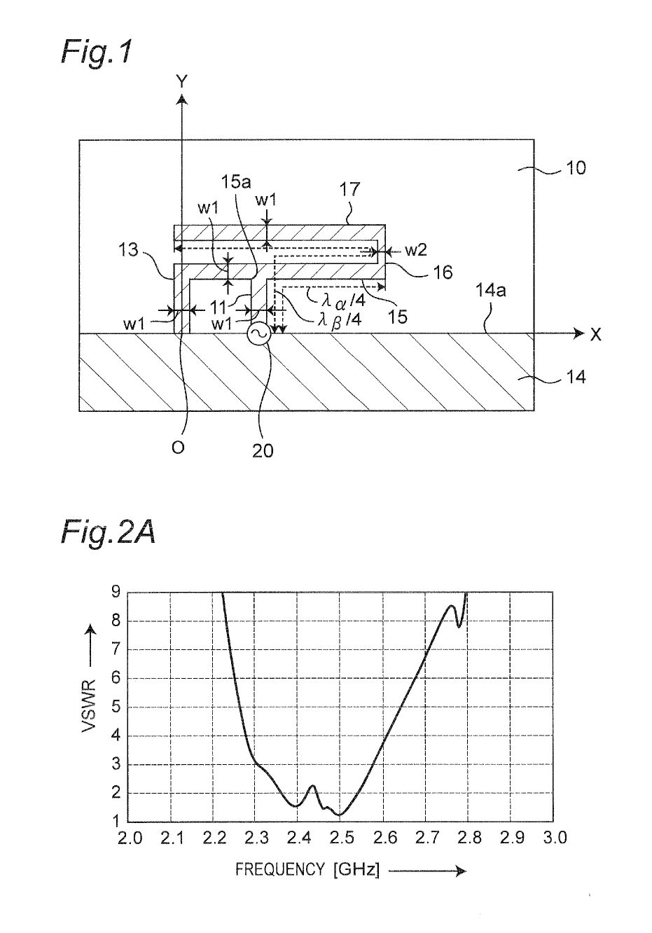

FIG. 1 is a plan view showing a configuration of an antenna apparatus according to the first preferred embodiment of the invention. Referring to FIG. 1, and FIGS. 3, 4, 5 and 6 described below, each antenna apparatus is described below by using the XY coordinates with one point on an upper surface of a grounding conductor 14 formed on a dielectric substrate 10 defined as a coordinate origin O, and it is assumed that the axis extending along a peripheral edge portion 14a of the grounding conductor 14 is an X axis, and the axis extending upward in each figure from the peripheral edge portion 14a of the grounding conductor 14 from the coordinate origin O is a Y axis. In this case, the opposite direction to the X-axis direction is referred to as a −X direction, and the opposite direction to the Y-axis direction is referred to as a −Y direction.

Referring to FIG. 1, the antenna apparatus of the present preferred embodiment is configured to include a feeding antenna element 11, a feeding point 20, a grounding antenna element 13, a grounding conductor 14, a first antenna element 15, a folded antenna element 16, and a second antenna element 17. The antenna elements 11 to 17 are each made of a conductor foil of Cu, Ag or the like formed on the dielectric substrate 10 of, for example, a printed circuit board or the like. It is noted that a grounding conductor may be formed or not formed on the back surface of the grounding conductor 14 via the dielectric substrate 10. Moreover, no grounding conductor is formed on the back surface via the dielectric substrate 10 of the portion where the antenna apparatus including the antenna elements 11 to 17 are formed. Further, the grounding conductor 14 should preferably be formed so that its extension length in the −Y direction becomes longer than the length of the second wavelength λβ. However, the grounding conductor 14 may not be formed when the grounding is achieved at another end of the feeding line upon feeding from the feeding point 20 via the feeding line, whereas it is preferable to form the grounding conductor 14 in order to radiate electromagnetic wave from the antenna apparatus with a comparatively high efficiency.

One end of the feeding antenna element 11 is connected to the feeding point 20, and the feeding antenna element 11 is formed to be substantially parallel to the Y-axis direction extending in the Y-axis direction. Then, another end of the feeding antenna element 11 is connected to a predetermined connecting point 15a of the first antenna element 15. One end of the grounding antenna element 13 is grounded to the grounding conductor 14 at the coordinate origin O, and the grounding antenna element 13 is formed along the Y axis extending in the Y-axis direction. Then, another end of the grounding antenna element 13 is connected to one end of the first antenna element 15. The first antenna element 15 is formed to be substantially parallel to the X axis, extending in the X-axis direction from another end (upper end in the figure) of the grounding antenna element 13 via the connecting point 15a. Then, another end of the first antenna element 15 is connected to one end of the folded antenna element 16. The folded antenna element 16 extends in the Y-axis direction from another end of the first antenna element 15, and is then connected to one end of the second antenna element 17. The second antenna element 17 is formed to be substantially parallel to the X-axis direction, extending in the −X-axis direction from another end of the folded antenna element 16, and then another end of the second antenna element 17 is an open end.

In the antenna apparatus as configured as above, the first antenna element 15 and the second antenna element 17 are formed to be substantially mutually parallel to the X axis and the line of the peripheral edge portion 14a of the grounding conductor 14 formed along the X axis.

In this case, as shown in FIG. 1, a first radiating element is configured to include an antenna element, that extends from the feeding point 20 via the feeding antenna element 11, further extending from the connecting point 15a via the first antenna element 15 to its other end. Its length (electrical length) is set to λα/4 that is the quarter wavelength of the first wavelength λα, and the first radiating element resonates at a first resonance frequency fα, allowing the wireless signal at a radio frequency that has the first resonance frequency fα to be transmitted and received. Moreover, a second radiating element is configured to include an antenna element, that extends from the feeding point 20 via the feeding antenna element 11, further extending from the connecting point 15a via the first antenna element 15 to its other end and further extending via the folded antenna element 16 and the second antenna element 17 to an open end at its other end. Its length (electrical length) is set to λβ/4 that is the quarter wavelength of the second wavelength λβ, and the second radiating element resonates at a second resonance frequency fβ, allowing the wireless signal at a radio frequency that has the second resonance frequency fβ to be transmitted and received.

Each of the antenna elements 11, 13, 15 and 17 has a predetermined width w1, and the folded antenna element 16 has a width w2 smaller than the width w1. In this case, the widths w1 and w2 are set so that the folded antenna element 16 has an impedance higher than a predetermined threshold impedance at the frequency of the first resonance frequency fα but has an impedance lower than the predetermined threshold impedance at the second resonance frequency fβ.

Further, the position and width w1 on the first antenna element 15 at the connecting point 15a are set so that impedance when seeing the wireless transceiver circuit (not shown) via the feeding line (not shown) from the feeding point 20 substantially coincides with impedance when seeing the antenna apparatus on the first antenna element 15 side from the feeding point 20. It is noted that, for example, a coaxial cable, a microstrip line or the like is used as the feeding line.

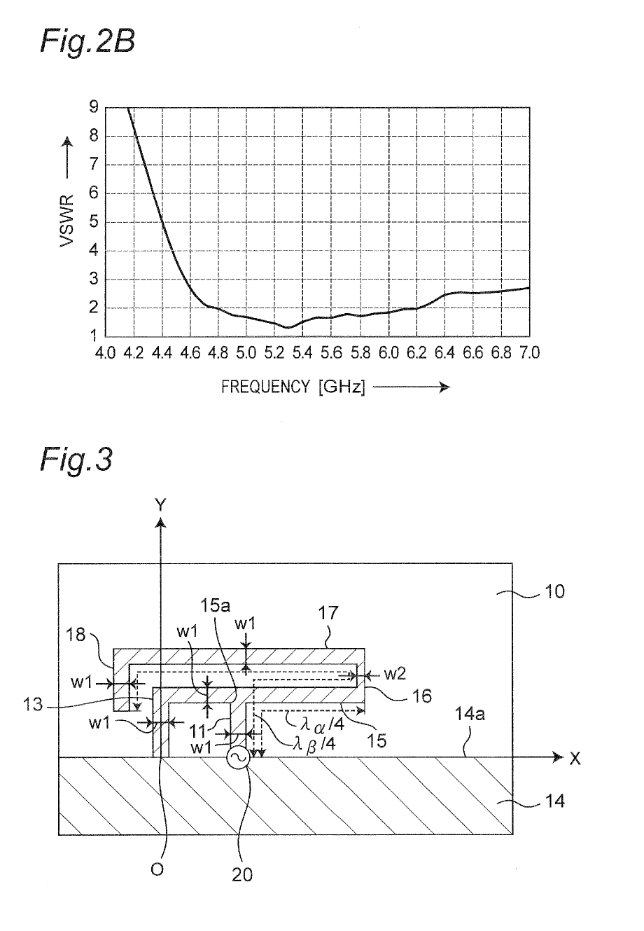

FIG. 2A is a graph showing a VSWR frequency characteristic in the vicinity of the second resonance frequency fβ in the antenna apparatus of FIG. 1, and FIG. 2B is a graph showing a VSWR frequency characteristic in the vicinity of the first resonance frequency fα in the antenna apparatus of FIG. 1. Impedance matching is obtained at 2.4 GHz including the resonance frequency fβ as apparent from FIG. 2A, and impedance matching is obtained at 5 GHz including the resonance frequency fβ as apparent from FIG. 2B.

The case where the first resonance frequency fα is in the 5-GHz band and the second resonance frequency fβ is in the 2.4-GHz band is considered hereinafter. Assuming that the wavelength of a radio wave is λ [m] (length of 0 to 360 degrees (2n) ⁱⁿ terms of a sine wave), the resonance frequency is fα [Hz] and the velocity of the radio wave is c [m/sec] (this is constant at 3×10⁸ [m/s] equal to the velocity of tight), then the wavelength and the frequency are expressed by the equation: λ [m]=c/fα.

First of all, when the first resonance frequency fα is 5 GHz, the first wavelength λα is expressed by the following equation:

Equation (1)

λα=c/fα=3×10⁸/(5×10⁹)=0.06 [m] (1)

Therefore, the length of the first radiating element is expressed by the following equation:

Equation (2)

λα/4=0.015 [m]=1.5 [cm] (2)

Next, when the second resonance frequency fβ is 2.4 GHz, the second wavelength λβ is expressed by the following equation.

Equation (3)

λβ=c/fβ=3×10⁸/(2.4×10⁹)=0.125 [m] (3)

Therefore, the length of the second radiating element is expressed by the following equation:

Equation (4)

λβ/4=0.03125 [m]≈3 [cm] (4)

As described above, when the first resonance frequency fα is in the 5-GHz band and the second resonance frequency fβ is in the 2.4-GHz band, a length of about 1.5 cm is needed as the length of the first radiating element at the first resonance frequency fα, and a length of about 3.0 cm is needed as the length of the second radiating element at the second resonance frequency fβ.

In this case, although an antenna width in the X-axis direction of about 3.0 cm is needed in the configuration of the general inverted F antenna, it is possible to reduce the antenna width to about 1.5 cm with the above configuration.

According to the antenna apparatus of the present preferred embodiment, the so-called inverted F pattern antenna apparatus, which resonates at the first wavelength λα and the second wavelength λβ, i.e., in the two frequency bands of the first resonance frequency and the second resonance frequency, can be made compact in comparison with the prior art.

### Second Preferred Embodiment

FIG. 3 is a plan view showing a configuration of an antenna apparatus according to the second preferred embodiment of the invention. The antenna apparatus of the second preferred embodiment is characterized by further including a third antenna element 18 that is provided at another end of the second antenna element 17 and extends from another end in the −Y-axis direction along and parallel to the grounding antenna element 13 in comparison with the antenna apparatus of the first preferred embodiment.

When the second antenna element 17 is longer than the first antenna element 15, the second antenna element disadvantageously protrudes in the −X-axis direction from the neighborhood of the first antenna element 15. However, providing of the third antenna element 18 bent toward the grounding antenna element 13 leads to that the total width (width in the X-axis direction) of the antenna apparatus can be narrowed, allowing the antenna apparatus to be reduced in size.

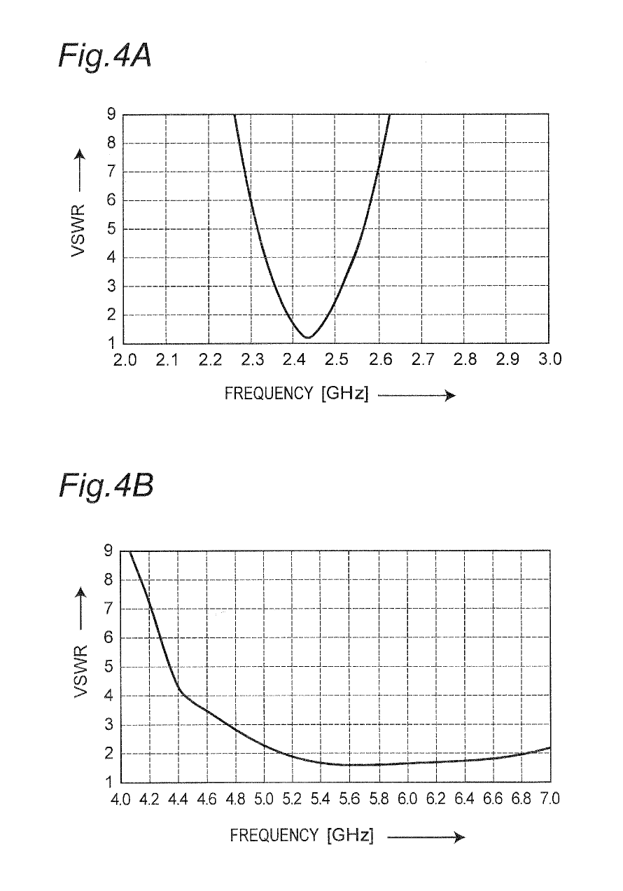

FIG. 4A is a graph showing a VSWR frequency characteristic in the vicinity of the second resonance frequency fβ in the antenna apparatus of FIG. 3, and FIG. 4B is a graph showing a VSWR frequency characteristic in the vicinity of the first resonance frequency fα in the antenna apparatus of FIG. 3. Impedance matching is obtained at 2.4 GHz including the resonance frequency as apparent from FIG. 4A, and impedance matching is obtained at 5 GHz including the resonance frequency fα as apparent from FIG. 4B.

Therefore, also in the present preferred embodiment, as calculated in the first preferred embodiment, when the first resonance frequency fα is in the 5-GHz band and the second resonance frequency fβ is in the 2.4-GHz band, an antenna element length of λα/4≈about 1.5 cm that is the quarter wavelength of the first wavelength λα is needed at the first resonance frequency fα, and an antenna element length of λβ/4≈about 3.0 cm is needed at the second resonance frequency fβ. That is, the first radiating element is configured to include an antenna element, that extends from the feeding point 20 via the feeding antenna element 11, further extending from the connecting point 15a via the first antenna element 15 to its other end. Its length (electrical length) is set to λα/4 that is the quarter wavelength of the first wavelength λα, and the first radiating element resonates at the first resonance frequency fα, allowing the wireless signal at a radio frequency that has the first resonance frequency fα to be transmitted and received. Moreover, the second radiating element is configured to include an antenna element that extends from the feeding point 20 via the feeding antenna element 11, further from the connecting point 15a via the first antenna element 15 to its other end, and further extending via the folded antenna element 16, the second antenna element 17 and the third antenna element 18 to an open end at its other end. Its length (electrical length) is set to λβ/4 that is the quarter wavelength of the second wavelength λβ, and the second radiating element resonates at the second resonance frequency λβ, allowing the wireless signal at a radio frequency that has the second resonance frequency fβ to be transmitted and received.

Therefore, according to the antenna apparatus of the present preferred embodiment shown in FIG. 3, an antenna width in the X-axis direction of about 3.0 cm is needed in the configuration of the general inverted F antenna, whereas it is possible to reduce the width (width in the X-axis direction) of the antenna apparatus to about 1.5 cm with the above configuration.

According to the antenna apparatus of the present preferred embodiment, the so-called inverted F pattern antenna apparatus, which resonates at the first wavelength λα and the second wavelength λβ, i.e., in the two frequency bands of the first resonance frequency and the second resonance frequency, can be made compact.

### Modified Preferred Embodiments

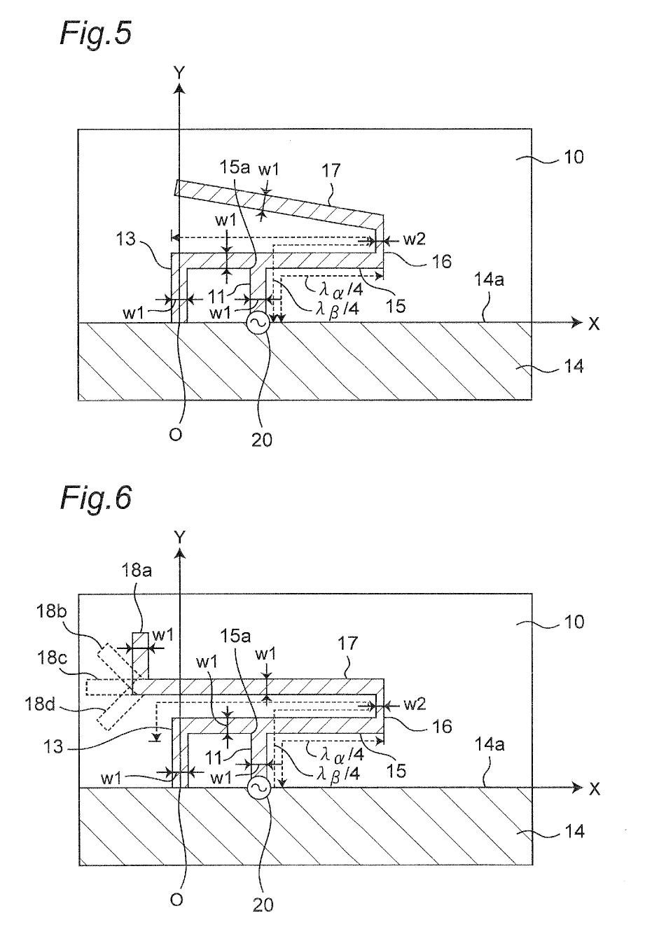

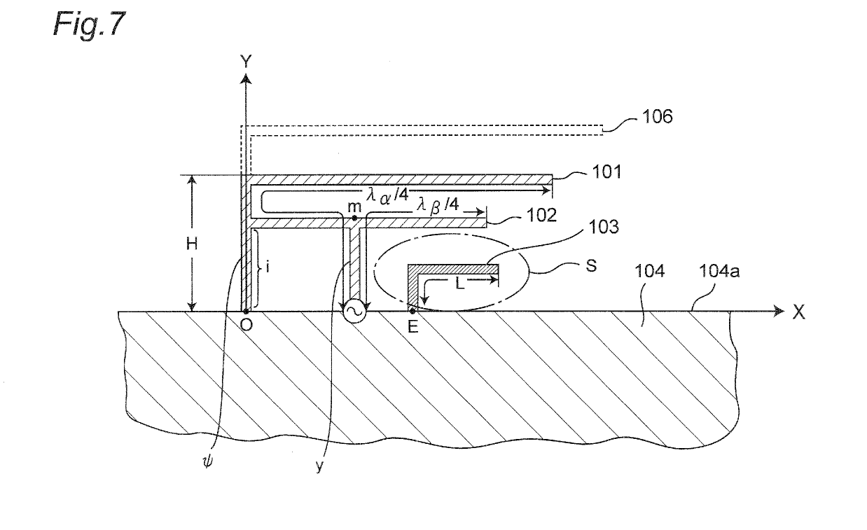

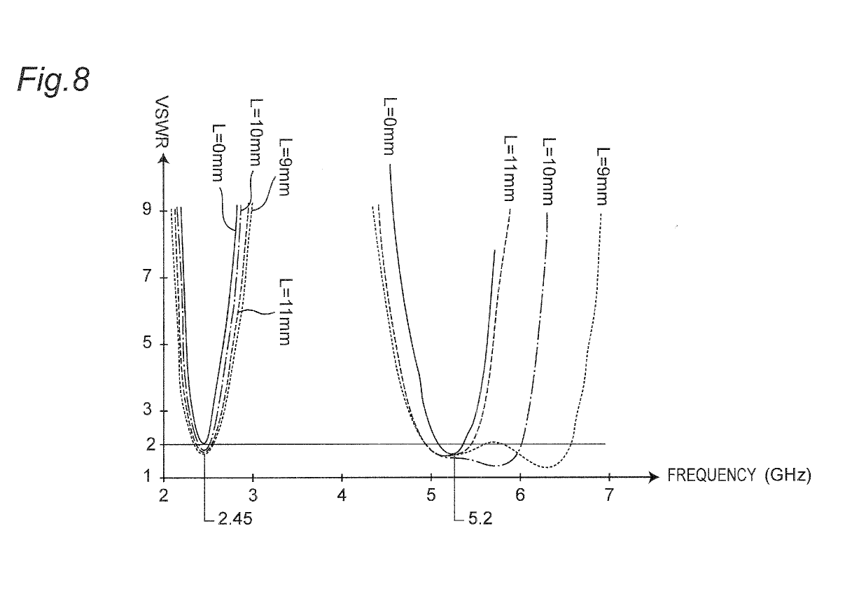

FIG. 5 is a plan view showing a configuration of an antenna apparatus according to a modified preferred embodiment of the first preferred embodiment. Although the first antenna element 15 and the second antenna element 17 are configured to be substantially parallel to each other in the first preferred embodiment, the invention is not limited to this, and it is acceptable to configure the second antenna element 17 inclined to the first antenna element 15 by a predetermined angle (exceeding zero degrees and smaller than 90 degrees). This configuration may also be applied to the second preferred embodiment.

FIG. 6 is a plan view showing a configuration of an antenna apparatus according to a modified preferred embodiment of the second preferred embodiment. Although the third antenna element 18 is configured to extend in the −Y-axis direction from another end of the second antenna element 17, the invention is not limited to this, and it may be configured to

(a) extend in the Y-axis direction like a third antenna element 18a,

(b) extend inclinedly at a predetermined angle of 45 degrees or certain degrees from the Y-axis direction like a third antenna element 18b,

(c) extend directly in the identical direction from the second antenna element 17 like a third antenna element 18c, or

(d) extend inclinedly at a predetermined angle of 135 degrees or certain degrees from the Y-axis direction like a third antenna element 18d.

Although the aforementioned preferred embodiments have been described with the first resonance frequency in the 5-GHz band and with the second resonance frequency in the 2.4-GHz band, the frequencies are not limited to these frequency bands.

Moreover, although the dielectric substrate 10 is used in the aforementioned preferred embodiments, the invention is not limited to this, and a substrate of a semiconductor substrate or the like may be used.

Furthermore, although the antenna elements 11 to 18 are formed of, for example, a conductor of Cu, Ag or the like formed on the dielectric substrate 10, the invention is not limited to this, and it is acceptable to configure a planner inverted F antenna apparatus by forming the antenna elements 11 to 18 of planner conductors (the antenna elements 15 and 17 have a planner shape having a surface parallel to the line of the peripheral edge portion 14a of the grounding conductor 14, and the antenna elements 13 and 16 have a planner shape having a surface perpendicular to the line of the peripheral edge portion 14a of the grounding conductor 14).

### INDUSTRIAL APPLICABILITY

As described in detail above, according to the invention, the antenna apparatus is allowed to have a width made to be about half that of the prior art in the inverted F antenna with resonating in the two frequency bands and allowed to be remarkably reduced in size. The antenna apparatus of the invention is useful as a miniaturization technology of the antenna that resonates in two frequency bands.

### REFERENCE NUMERALS

10: dielectric substrate,

11: feeding antenna element,

13: grounding antenna element,

14: grounding conductor,

14a: peripheral edge portion of grounding conductor,

15: first antenna element,

16: folded antenna element,

17: second antenna element,

18, 18a, 18b, 18c, 18d: third antenna element, and

20: feeding point.

1. An antenna apparatus comprising:
a grounding antenna element having one end connected to a grounding conductor;
a first antenna element formed to be substantially parallel to a peripheral edge portion of the grounding conductor, the first antenna element having one end connected to another end of the grounding antenna element;
a feeding antenna element that connects a feeding point with a predetermined connecting point on the first antenna element;
a folded antenna element having one end connected to another end of the first antenna element; and
a second antenna element having one end connected to another end of the folded antenna element,
wherein a first length from the feeding point via the feeding antenna element, the connecting point on the first antenna element, and the first antenna element to another end of the first antenna element is set to a length of a quarter wavelength of a first resonance frequency, whereby the antenna apparatus resonates at a first resonance frequency by a first radiating element having the first length, and
wherein a second length from the feeding point via the feeding antenna element, the connecting point on the first antenna element, the first antenna element, the folded antenna element, the second antenna element to another end of the second antenna element is set to a length of a quarter wavelength of a second resonance frequency, whereby the antenna apparatus resonates at a second resonance frequency by a second radiating element having the second length.

2. The antenna apparatus as claimed in claim 1,
wherein the grounding antenna element is formed to be substantially perpendicular to the peripheral edge portion of the grounding conductor,
wherein the folded antenna element is formed to be substantially perpendicular to the peripheral edge portion of the grounding conductor, and
wherein the second antenna element is formed to be substantially parallel to the peripheral edge portion of the grounding conductor.

3. The antenna apparatus as claimed in claim 1,
wherein the first antenna element, the second antenna element, the folded antenna element, the feeding antenna element and the grounding antenna element are formed on a substrate.

4. The antenna apparatus as claimed in claim 3,
wherein the folded antenna element has a width smaller than the width of each of the first antenna element and the second antenna element.

5. The antenna apparatus as claimed in claim 1,
wherein another end of the second antenna element is formed to be bent at a predetermined angle.

6. The antenna apparatus as claimed in claim 5,
wherein another end of the second antenna element is formed to be bent in a direction toward the peripheral edge portion of the grounding conductor.
